(19) United States
(12) Patent Application Publication
(10) Pub. No.: US 2020/0099901 A1
(43) Pub. Date: Mar. 26, 2020

(54) PROJECTION DEVICE AND LIGHT SOURCE MODULE THEREOF AND METHOD OF SYNCHRONIZING WAVELENGTH CONVERSION WHEEL AND FILTER WHEEL

(71) Applicant: Coretronic Corporation, Hsin-Chu (TW)

(72) Inventors: Tung-Yi Lu, Hsin-Chu (TW); Shun-Tai Chen, Hsin-Chu (TW); Chen-Yi Hong, Hsin-Chu (TW); Wen-Hsin Chang, Hsin-Chu (TW)

(73) Assignee: Coretronic Corporation, Hsin-Chu (TW)

(21) Appl. No.: 16/579,789

(22) Filed: Sep. 23, 2019

(30) Foreign Application Priority Data
Sep. 26, 2018 (CN) 201811124177.7

(51) Int. Cl. H04N 9/31; G03B 21/20; G02B 26/00

(52) U.S. Cl. CPC H04N 9/3126; H04N 9/3114; G02B 26/008; G03B 21/204

(57) ABSTRACT

A projection device and a light source module thereof and a method for synchronizing a wavelength conversion wheel and a filter wheel are provided. A rotation state of the wavelength conversion wheel and a rotation state of the filter wheel are detected to generate a first position signal and a second position signal, respectively. A control unit is used to control one of the wavelength conversion wheel and the filter wheel to rotate. A micro control unit is used to control the other one of the wavelength conversion wheel and the filter wheel to rotate according to the first position signal and the second position signal, so that the wavelength conversion wheel and the filter wheel rotate synchronously. The disclosure enables the wavelength conversion wheel and the filter wheel to synchronize in the circumstances where the control unit only supports controlling of one wavelength conversion wheel or filter wheel.

### CROSS-REFERENCE TO RELATED APPLICATION

This application claims the priority benefit of China application serial no. 201811124177.7, filed on Sep. 26, 2018. The entirety of the above-mentioned patent application is hereby incorporated by reference herein and made a part of this specification.

### BACKGROUND OF THE DISCLOSURE

### Field of the Disclosure

The disclosure relates to a display device, and more particularly to a projection device and a light source module thereof and a method of synchronizing wavelength conversion wheel and filter wheel.

### Description of Related Art

A projector is a display device for generating a large-sized frame. The imaging principle of the projector is to convert the illumination beam generated by a light source module into an image beam through a light valve, and then the image beam is projected onto a screen or wall through the lens to form an image. With the advancement of projection technology and the reduction of manufacturing costs, the use of projectors has gradually expanded from commercial use to household use.

In the structure of a laser projector, it mainly produces a beam of a desired color by making a blue laser beam to sequentially pass through a wavelength conversion wheel and a filter wheel. A projection device with such structure requires synchronization of the wavelength conversion wheel and the filter wheel. In general, the wavelength conversion wheel and the filter wheel are controlled to synchronize by an image processor, but in the circumstances where the image processor does not have the function of controlling the wavelength conversion wheel and the filter wheel to synchronize with a digital micro-mirror device, it is impossible for the projection device to display the image frame normally.

The information disclosed in this BACKGROUND section is only for enhancement of understanding of the BACKGROUND section of the described technology and therefore it may contain information that does not form the prior art that is already known to a person of ordinary skill in the art. Further, the information disclosed in the BACKGROUND section does not mean that one or more problems to be resolved by one or more embodiments of the disclosure was acknowledged by a person of ordinary skill in the art.

SUMMARY OF THE DISCLOSURE

The disclosure provides a projection device and a light source module and a method for synchronizing a wavelength conversion wheel and a filter wheel, making it possible for the wavelength conversion wheel and the filter wheel to be synchronized in the circumstances where a control unit only supports controlling of one wavelength conversion wheel or filter wheel, such that the projection device can display the image frame normally.

The objectives and advantages of the disclosure may be further understood in the technical features disclosed in the disclosure.

To achieve one or a part or all the objectives or other objectives, an embodiment of the disclosure provides a projection device including a light source module, an imaging component, and a projection lens. The light source module includes a light source, a wavelength conversion wheel, a filter wheel, a first driving unit, a second driving unit, a micro control unit, and a control unit. The light source provides an excitation beam. The wavelength conversion wheel is disposed on a transmitting path of the excitation beam, and converts the excitation beam to generate a converted beam. The filter wheel is disposed on a transmitting path of the excitation beam and the converted beam, and filters a waveband of a portion of the converted beam to generate at least one color light beam. The light source module forms an illumination beam according to the excitation beam and the at least one color light beam. The first driving unit drives the wavelength conversion wheel to rotate. The second driving unit drives the filter wheel to rotate. The control unit controls one of the first driving unit and the second driving unit to drive, and the micro control unit controls the other one of the first driving unit and the second driving unit to drive, such that the wavelength conversion wheel rotates synchronously with the filter wheel. The imaging component is disposed on the transmitting path of the illumination beam to convert the illumination beam into an image beam. The projection lens is disposed on the transmitting path of the image beam and is adapted for projecting the image beam to a projection target.

The disclosure further provides a light source module, including a light source, a wavelength conversion wheel, a filter wheel, a first driving unit, a second driving unit, a micro control unit and a control unit. The light source provides an excitation beam.

The wavelength conversion wheel is disposed on the transmitting path of the excitation beam, and converts the excitation beam to generate a converted beam. The filter wheel is disposed on the transmitting path of the excitation beam and the converted beam, and filters the waveband of a portion of the converted beam to generate at least one color light beam, and the light source module forms an illumination beam according to the excitation beam and the at least one color light beam. The first driving unit drives the wavelength conversion wheel to rotate. The second driving unit drives the filter wheel to rotate. The control unit controls one of the first driving unit and the second driving unit to drive, and the micro control unit controls the other one of the first driving unit and the second driving unit to drive, such that the wavelength conversion wheel rotates synchronously with the filter wheel.

The disclosure further provides a method for synchronizing a wavelength conversion wheel and a filter wheel of a projection device. The projection device includes a wavelength conversion wheel and a filter wheel, the method for synchronizing the wavelength conversion wheel and the filter wheel of the projection device includes the following steps. The rotation state of the wavelength conversion wheel and the rotation state of the filter wheel are detected to generate a first position signal and a second position signal, respectively. A control unit is used to control one of the wavelength conversion wheel and the filter wheel to rotate. The micro control unit is used to control the other one of the wavelength conversion wheel and the filter wheel to rotate according to the first position signal and the second position signal, such that the wavelength conversion wheel and the filter wheel rotate synchronously.

Based on the above, the embodiment of the disclosure controls the rotation of the wavelength conversion wheel and the filter wheel respectively through the control unit and the micro control unit, so that even if the control unit only supports controlling of one wavelength conversion wheel or filter wheel, the wavelength conversion wheel and the filter wheel can still be synchronized to enable the projection device to display the image frame normally.

In order to make the aforementioned features and advantages of the disclosure more comprehensible, embodiments accompanying figures are described in detail below.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection device according to an embodiment of the disclosure.

FIG. 2 is a schematic view of a projection device according to another embodiment of the disclosure.

FIG. 3 is a schematic view illustrating a detecting unit detecting rotation of a wavelength conversion wheel according to an embodiment of the disclosure.

FIG. 4 is a waveform diagram showing a position signal 51 and a position signal S2 according to an embodiment of the disclosure.

FIG. 5 is a flow chart illustrating a method for synchronizing a wavelength conversion wheel and a filter wheel of a projection device according to an embodiment of the disclosure.

### DESCRIPTION OF EMBODIMENTS

The above and other technical contents, features and effects of the disclosure will be clear from the below detailed description of an embodiment of the disclosure with reference to accompanying drawings. The directional terms mentioned in the embodiments below, like “above”, “below”, “left”, “right”, “front”, and “back” refer to the directions in the appended drawings. Therefore, the directional terms are only used for illustration instead of limiting the disclosure.

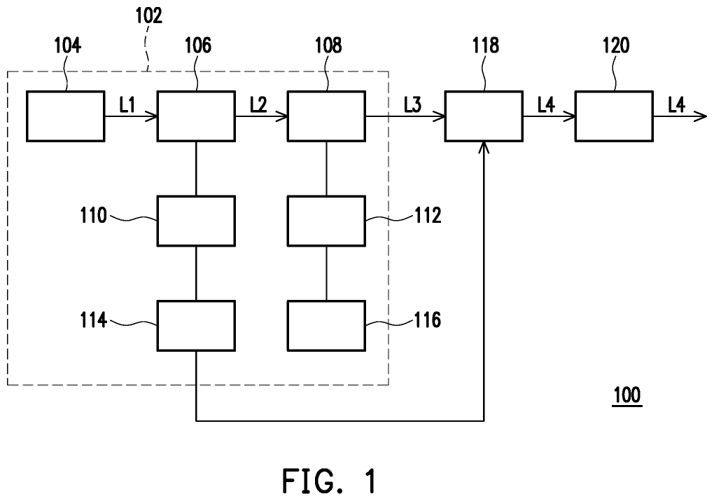

FIG. 1 is a schematic view of a projection device according to an embodiment of the disclosure, please refer to FIG. 1. A projection device 100 includes a light source module 102, an imaging component 118, and a projection lens 120. The light source module 102 is configured to provide an illumination beam L3 to the imaging component 118. The imaging component 118 may be, for example, a reflective type light modulator such as a liquid crystal on silicon panel (LCoS panel), a digital micro-mirror device (DMD), or the like, or a transmissive type light modulator such as a transparent liquid crystal panel, an electro-optical modulator, a magneto-optic modulator, an acousto-optic modulator (AOM) or the like. However, the disclosure is not limited thereto. The imaging component 118 is disposed on the transmitting path of the illumination beam L3, and the imaging component 118 may be controlled by a control unit 114 to convert the illumination beam L3 into an image beam L4. The projection lens 120 is disposed on the transmitting path of the image beam L4, and capable of projecting the image beam L4 onto a projection target (such as a wall surface or a projection screen) to form a projection frame on the projection target.

Further, the light source module 102 may include a light source 104, a wavelength conversion wheel 106, a filter wheel 108, a driving unit 110, a driving unit 112, the control unit 114, and a micro control unit 116. Specifically, the light source 104 may provide an excitation beam L1, the wavelength conversion wheel 106 is disposed on the transmitting path of the excitation beam L1, and capable of converting the excitation beam L1 to generate a converted beam L2. The filter wheel 108 is disposed on the transmitting path of excitation beam L1 and converted beam L2, and filters the waveband of a portion of the converted beam L2 to filter out the light beam of the unwanted waveband to generate at least one color light beam. With the above configuration of the light source 104, the wavelength conversion wheel 106, and the filter wheel 108, the light source module 102 is capable to form the illumination beam L3 according to the excitation beam L1 and the at least one color light beam.

For example, the light source 104 may be, for example, a blue laser light source that can provide a blue laser beam, and the wavelength conversion wheel 106 may be, for example, a phosphor wheel having a light transmitting region and including phosphor powder disposed thereon, the filter wheel 108 having a transparent region and a plurality of filter regions of different colors. When the blue laser beam provided by the light source 104 illuminates the phosphor powder of the wavelength conversion wheel 106, the phosphor powder is excited by the blue laser beam to emit a yellow light beam (the converted beam L2), and a portion of the yellow light beam may pass through the red filter on the filter wheel 108 to form red light, and a portion of the yellow light beam passes through the transparent region of the filter wheel 108 to form a yellow light beam. In addition, the blue laser beam provided by the light source 104 may be transmitted through a portion of the light transmitting region of the wavelength conversion wheel 106, and then pass through the transparent region on the filter wheel 108 to form a blue light beam, such that the light source module 102 can provide an illumination beam L3 including light beams of different colors.

In the exemplary embodiment, the driving unit 110 is coupled to the wavelength conversion wheel 106 and the control unit 114, and the driving unit 112 is coupled to the filter wheel 108 and the micro control unit 116, wherein the control unit 114 may be implemented as an image processor, for example, but is not limited thereto. The control unit 114 is configured to control the driving unit 110 to drive the wavelength conversion wheel 106 to rotate, and the micro control unit 116 may control the driving unit 112 to drive the filter wheel 108 to rotate in synchronization with the wavelength conversion wheel 106, so that the filter wheel 108 and the wavelength conversion wheel 106 are capable to convert the excitation beam L1 into the illumination beam L3 required for projection. Thus, by providing the micro control unit 116 to control the driving unit 112 to drive the filter wheel 108 to rotate, in the circumstances where the control unit only supports controlling of one wavelength conversion wheel 106 or the filter wheel 108, the wavelength conversion wheel 106 and the filter wheel 108 can still be synchronized, such that the projection device displays the image frame normally.

It should be noted that in other embodiments, the driving unit 110 may also be controlled by the control unit 114 to drive the filter wheel 108 to rotate, and the micro control unit 116 controls the driving unit 112 to drive the wavelength conversion wheel 106 to rotate, such that the wavelength conversion wheel 106 rotates in synchronization with the filter wheel 108. As long as the wavelength conversion wheel 106 and the filter wheel 108 can be rotated synchronously, the disclosure provides no limitation to the control objects of the control unit 114 and the micro control unit 116.

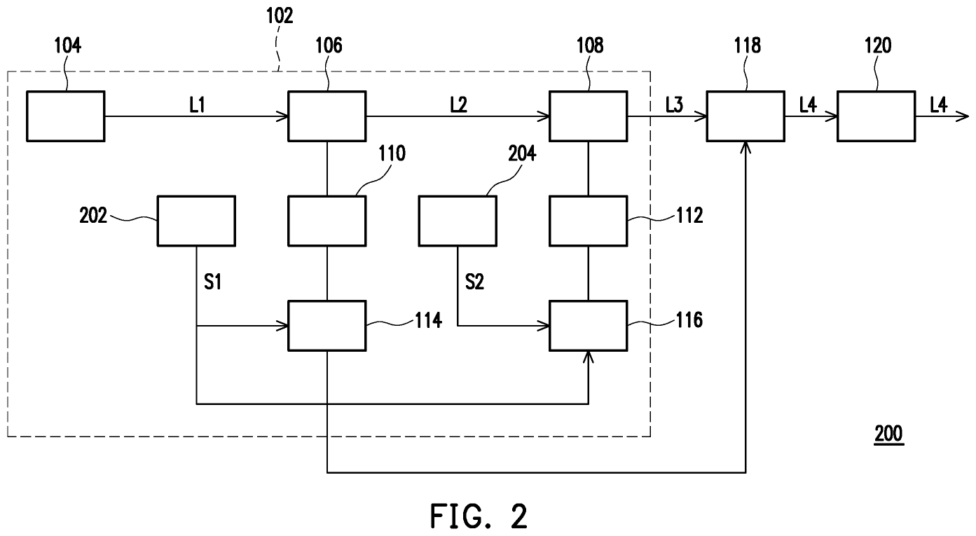

FIG. 2 is a schematic view of a projection device according to another embodiment of the disclosure, please refer to FIG. 2. In the exemplary embodiment, a projection device 200 further includes a detecting unit 202 and a detecting unit 204 as compared to the projection device 100, and the detecting unit 202 is coupled to the control unit 114 and the micro control unit 116, and the detecting unit 204 is coupled to the micro control unit 116. Specifically, the detecting unit 202 is configured to detect the rotation state of the wavelength conversion wheel 106 to generate a corresponding position signal 51 to the control unit 114 and the micro control unit 116, and the detecting unit 204 is configured to detect the rotation state of the filter wheel 108 to generate a corresponding position signal S2 to the micro control unit 116. Thus, the control unit 114 can stably control the wavelength conversion wheel 106 to rotate at a preset rotation speed according to the position signal 51, and the micro control unit 116 can control the filter wheel 108 to rotate synchronously with the wavelength conversion wheel 106 according to the position signal 51 and the position signal S2.

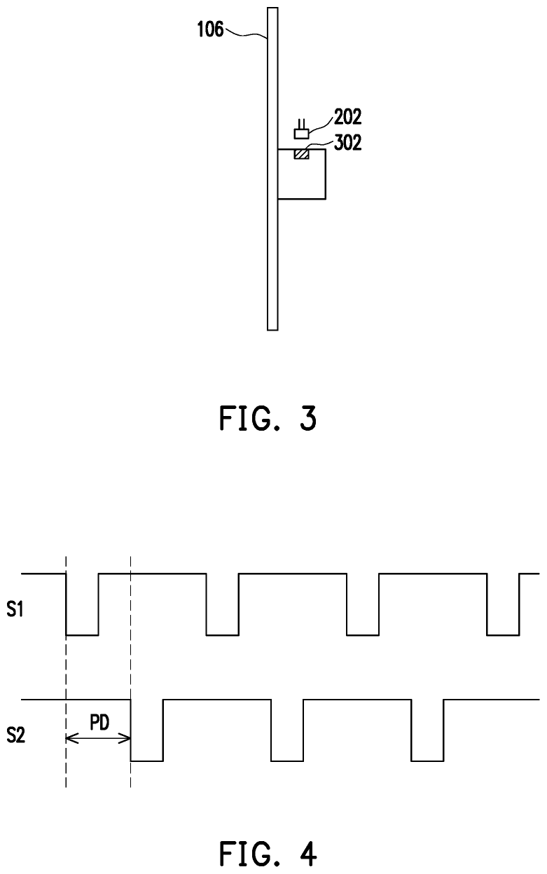

Further, the detecting unit 202 may detect the rotation of the wavelength conversion wheel 106 in the manner as shown in FIG. 3, for example. A time tag 302 has a fixed relative position with respect to the wavelength conversion wheel 106, and the detecting unit 202 may generate the position signal 51 by detecting the time tag 302 rotating with the wavelength conversion wheel 106. For example, the driving unit 110 may be implemented as a motor, and the time tag 302 may be disposed, for example, on a rotating shaft of the motor, and the time tag 302 is rotated with a rotating shaft that drives the wavelength conversion wheel 106 to rotate. The detecting unit 202 may be implemented, for example, as an optical sensor that can detect the time tag 302 to generate the position signal S1. Similarly, the manner in which the detecting unit 204 detects the rotation of the filter wheel 108 may also be implemented in the same manner as the embodiment of FIG. 3, and no repetitions are incorporated herein.

Specifically, when the projection device 200 is powered on, the control unit 114 may drive the wavelength conversion wheel 106 to rotate before the light source 104 provides the excitation beam L1 to avoid the damage of the wavelength conversion wheel 106 caused by the excitation beam L1. In addition, the micro control unit 116 may also simultaneously control the driving unit 112 to drive the filter wheel 108 to rotate together with the wavelength conversion wheel 106. When the position signal S2 outputted by the detecting unit 204 is determined that the filter wheel 108 is static by the micro control unit 116, the micro control unit 116 may restart the filter wheel 108. If the restart is unsuccessful for a preset number of times, the micro control unit 116 may inform the projection device 200 to display the information that the filter wheel 108 is malfunction. If the filter wheel 108 is successfully restarted, the micro control unit 116 may determine whether the rotation speed of the filter wheel 108 is consistent with the wavelength conversion wheel 106. If the rotation speed of the filter wheel 108 is not consistent with the wavelength conversion wheel 106, the micro control unit 116 adjusts the rotation speed of the filter wheel 108 to be consistent with the wavelength conversion wheel 106.

When the rotation speed of the filter wheel 108 is equal to the rotation speed of the wavelength conversion wheel 106, the micro control unit 116 may lock the rotation speed of the filter wheel 108, and determine whether the phase difference between the wavelength conversion wheel 106 and the filter wheel 108 is within a preset range, if the phase difference is within the preset range, the micro control unit 116 maintains locking the rotation speed of the filter wheel 108. For example, FIG. 4 is a waveform diagram illustrating the position signal S1 and position signal S2 according to an embodiment of the disclosure. When the detecting unit detects the time tag, the position signal is at a logical low level, and when the detecting unit does not detect the time tag, the position signal is at a logical high level. As shown in FIG. 4, whether the phase difference between the wavelength conversion wheel 106 and the filter wheel 108 is within a preset range may be determined, for example, according to a time difference PD between occurrence of the falling edge of the position signal S1 and the position signal S2. For example, when the time difference PD is within the preset time range, it may be determined that the phase difference between the wavelength conversion wheel 106 and the filter wheel 108 is within a preset range. If the time difference PD is not within the preset time range, that is, the phase difference is not within the preset range, the micro control unit 116 may slightly adjust the rotation speed of the filter wheel 108 until the phase difference between the filter wheel 108 and the wavelength conversion wheel 106 falls within the preset range, the rotation speed of the filter wheel 108 is locked afterward.

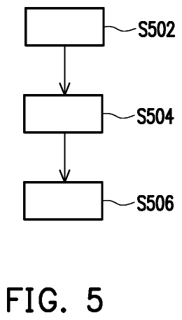

FIG. 5 is a flow chart illustrating a method for synchronizing a wavelength conversion wheel and a filter wheel of a projection device according to an embodiment of the disclosure. It can be obtained from the above embodiment that the method for synchronizing the wavelength conversion wheel and the filter wheel of the projection device may at least include the following steps. First, the rotation state of the wavelength conversion wheel and the rotation state of the filter wheel are detected to generate a first position signal and a second position signal, respectively (step S502).

Then, the control unit is used to control one of the wavelength conversion wheel and the filter wheel to rotate (step S504), wherein the control unit may be, for example, an image processor, but is not limited thereto. Then, the micro control unit is used to control the other one of the wavelength conversion wheel and the filter wheel to rotate according to the first position signal and the second position signal, so that the wavelength conversion wheel and the filter wheel rotate synchronously (step S506). For example, the control unit may be used to control the wavelength conversion wheel to rotate at a preset speed according to the first position signal, and the micro control unit is used to adjust the rotation speed of the filter wheel according to the first position signal and the second position signal, such that the filter wheel has the same rotation speed as the wavelength conversion wheel, and the phase difference between the filter wheel and the wavelength conversion wheel falls within the preset range.

In summary, the embodiment of the disclosure controls the rotation of the wavelength conversion wheel and the filter wheel respectively through the control unit and the micro control unit, so that even if the control unit only supports controlling of one wavelength conversion wheel or filter wheel, the wavelength conversion wheel and the filter wheel can still be synchronized to enable the projection device to display the image frame normally.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A projection device, comprising: a light source module, an imaging component, and a projection lens, wherein:
the light source module comprises a light source, a wavelength conversion wheel, a filter wheel, a first driving unit, a second driving unit, a micro control unit, and a control unit, wherein,
the light source provides an excitation beam;
the wavelength conversion wheel is disposed on a transmitting path of the excitation beam, and converts the excitation beam to generate a converted beam;
the filter wheel is disposed on a transmitting path of the excitation beam and the conversion beam, and filters a waveband of a portion the converted beam to generate at least one color light beam, and the light source module forms an illumination beam according to the excitation beam and the at least one color light beam;
the first driving unit drives the wavelength conversion wheel to rotate;
the second driving unit drives the filter wheel to rotate; and
the control unit controls one of the first driving unit and the second driving unit to perform driving, and the micro control unit controls the other one of the first driving unit and the second driving unit to perform driving, such that the wavelength conversion wheel and the filter wheel are rotated synchronously;
the imaging component is disposed on a transmitting path of the illumination beam to convert the illumination beam into an image beam; and
the projection lens is disposed on a transmitting path of the image beam, and is adapted to project the image beam onto a projection target.

2. The projection device according to claim 1, further comprising:
a first detecting unit, detecting a rotation state of the wavelength conversion wheel to generate a first position signal; and
a second detecting unit, detecting a rotation state of the filter wheel to generate a second position signal, wherein the control unit and the micro control unit control the first driving unit and the second driving unit to perform driving according to the first position signal and the second position signal, such that the wavelength conversion wheel is rotated synchronously with the filter wheel.

3. The projection device according to claim 2, wherein the control unit controls the first driving unit to drive the wavelength conversion wheel to rotate at a preset rotation speed according to the first position signal, the micro control unit controls the second driving unit to adjust a rotation speed of the filter wheel according to the first position signal and the second position signal, such that the filter wheel has the same rotation speed as the wavelength conversion wheel, and a phase difference between the filter wheel and the wavelength conversion wheel falls within a preset range.

4. The projection device according to claim 2, wherein the first driving unit and the second driving unit respectively have a first time tag and a second time tag disposed thereon, the first time tag and the second time tag rotate with the wavelength conversion wheel and the filter wheel respectively, the first time tag and the wavelength conversion wheel have a fixed relative position, the second time tag and the filter wheel have a fixed relative position, the first detecting unit and the second detecting unit respectively include a first optical sensor and a second optical sensor, and the first optical sensor and the second optical sensor respectively detect the first time tag and the second time tag to generate the first position signal and the second position signal.

5. The projection device according to claim 1, wherein the control unit comprises an image processor.

6. A light source module, comprising: a light source, a wavelength conversion wheel, a filter wheel, a first driving unit, a second driving unit, a micro control unit, and a control unit, wherein,
the light source provides an excitation beam;
the wavelength conversion wheel is disposed on a transmitting path of the excitation beam, and converts the excitation beam to generate a converted beam;
the filter wheel is disposed on a transmitting path of the excitation beam and the converted beam, and filters a waveband of a portion of the converted beam to generate at least one color light beam, and the light source module forms an illumination beam according to the excitation beam and the at least one color light beam;
the first driving unit drives the wavelength conversion wheel to rotate;
the second driving unit drives the filter wheel to rotate; and
the control unit controls one of the first driving unit and the second driving unit to perform driving, and the micro control unit controls the other one of the first driving unit and the second driving unit to perform driving, such that the wavelength conversion wheel is rotated synchronously with the filter wheel.

7. The light source module according to claim 6, further comprising:
a first detecting unit, detecting a rotation state of the wavelength conversion wheel to generate a first position signal; and
a second detecting unit, detecting a rotation state of the filter wheel to generate a second position signal, wherein the control unit and the micro control unit control the first driving unit and the second driving unit to perform driving according to the first position signal and the second position signal, such that the wavelength conversion wheel is rotated synchronously with the filter wheel.

8. The light source module according to claim 7, wherein the control unit controls the first driving unit to drive the wavelength conversion wheel to rotate at a preset rotation speed according to the first position signal, the micro control unit controls the second driving unit to adjust a rotation speed of the filter wheel according to the first position signal and the second position signal, such that the filter wheel has the same rotation speed as the wavelength conversion wheel, and a phase difference between the filter wheel and the wavelength conversion wheel falls within a preset range.

9. The light source module according to claim 7, wherein the first driving unit and the second driving unit respectively have a first time tag and a second time tag disposed thereon, the first time tag and the second time tag rotate with the wavelength conversion wheel and the filter wheel respectively, the first time tag and the wavelength conversion wheel have a fixed relative position, the second time tag and the filter wheel have a fixed relative position, the first detecting unit and the second detecting unit respectively include a first optical sensor and a second optical sensor, and the first optical sensor and the second optical sensor respectively detect the first time tag and the second time tag to generate the first position signal and the second position signal.

10. The light source module according to claim 6, wherein the control unit comprises an image processor.

11. A method for synchronizing a wavelength conversion wheel and a filter wheel of a projection device, wherein the projection device comprises a wavelength conversion wheel and a filter wheel, and the method for synchronizing the wavelength conversion wheel and the filter wheel of the projection device comprises:
detecting a rotation state of the wavelength conversion wheel and a rotation state of the filter wheel to generate a first position signal and a second position signal, respectively;
controlling one of the wavelength conversion wheel and the filter wheel to rotate by using a control unit; and
controlling, by a micro control unit, the other one of the wavelength conversion wheel and the filter wheel to rotate according to the first position signal and the second position signal, such that the wavelength conversion wheel is rotated synchronously with the filter wheel.

12. The method for synchronizing the wavelength conversion wheel and the filter wheel of the projection device according to claim 11, comprising:
controlling, by the control unit, the wavelength conversion wheel to rotate at a preset speed according to the first position signal; and
adjusting, by the micro control unit, a rotation speed of the filter wheel according to the first position signal and the second position signal, such that the filter wheel has the same rotation speed as the wavelength conversion wheel, and a phase difference between the filter wheel and the wavelength conversion wheel falls within a preset range.

13. The method for synchronizing the wavelength conversion wheel and the filter wheel of the projection device according to claim 11, wherein the control unit comprises an image processor.
